(19) United States
(12) Patent Application Publication
(10) Pub. No.: US 2023/0064398 A1
(43) Pub. Date: Mar. 2, 2023

(54) UEFI EXTENSIONS FOR ANALYSIS AND REMEDIATION OF BIOS ISSUES IN AN INFORMATION HANDLING SYSTEM

(71) Applicant: Dell Products L.P., Round Rock, TX (US)

(72) Inventors: Balasingh P. SAMUEL, Round Rock, TX (US); Jacob MINK, Austin, TX (US); Michael W. ARMS, Pflugerville, TX (US); Richard M. TONRY, Austin, TX (US)

(73) Assignee: Dell Products L.P., Round Rock, TX (US)

(21) Appl. No.: 17/459,210

(22) Filed: Aug. 27, 2021

(51) Int. Cl. G06F 9/4401; G06F 8/654; G06F 11/36; G06F 11/30

(52) U.S. Cl. CPC G06F 9/4401; G06F 8/654; G06F 11/3051; G06F 11/3058; G06F 11/3612

(57) ABSTRACT

A system and method for resolving (BIOS) firmware issues affecting one or more information handling systems, includes: responsive to receiving information indicative of the BIOS firmware issue, developing one or more executable scripts for resolving the BIOS firmware issue without modifying the BIOS firmware. The executable scripts include a first script for collecting data pertaining to the BIOS firmware issue, which is pushed to at least one affected information handling system. The first script includes processor-executable instructions that the affected information handling system executes in a pre-boot state to perform operations including establishing a secure and privileged pre-boot session, collecting data associated with the BIOS firmware issue from within the secure and privileged pre-boot session, and sending the data associated with the BIOS issue to a support resource.

### TECHNICAL FIELD

The present disclosure relates to remediation of faulty information handling systems and more specifically, remediation of BIOS firmware issues.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When a BIOS-related problem associated with a platform is first reported, the issue may not be easily reproducible/resolvable in the lab, in which case resolution may require collection of additional data pertaining to the issue. This may require the development and release of multiple BIOS updates, including a first BIOS update just to collect relevant data, followed by a second BIOS update to fix the issue. The multiple update paradigm for resolving BIOS issues conflicts with generally significant customer resistance to BIOS updates.

### SUMMARY

Common problems associated with analyzing and remediating BIOS issues are addressed by systems and methods disclosed herein. In accordance with subject matter disclosed in the following description, a system and method for resolving (BIOS) firmware issues affecting one or more information handling systems, includes: responsive to receiving information indicative of the BIOS firmware issue, developing one or more executable scripts for resolving the BIOS firmware issue without modifying the BIOS firmware.

The executable scripts include a first script for collecting data pertaining to the BIOS firmware issue, which is pushed to at least one affected information handling system. The first script includes processor-executable instructions that the affected information handling system executes in a pre-boot state to perform operations including establishing a secure and privileged pre-boot session, collecting data associated with the BIOS firmware issue from within the secure and privileged pre-boot session, and sending the data associated with the BIOS issue to a support resource.

The method may further include performing analysis of the data associated with the BIOS firmware issue, developing, based on the analysis, a second script referred to herein as the pre-boot remediation script, wherein the pre-boot remediation script, when executed, resolves the BIOS firmware issue, and pushing the remediation script to the affected information handling system. The method may further include developing, based on the analysis, a third script, referred to herein as a pre-boot forensic script for proactively identifying susceptibility to the BIOS firmware issue and pushing the pre-boot forensic script to one or more “like” information handling systems, i.e., a system with the same or substantially the same configuration as the affected information handling system.

Collecting the data associated with the BIOS firmware issue may include collecting telemetry data generated by telemetry hardware of the information handling system. The telemetry hardware may include one or more environmental sensors, for telemetry data indicative of one or environmental parameters associated with the information handling system, and/or one or more model specific registers for telemetry data indicative of any one or more performance parameters including, as non-limiting examples: system configuration parameters, log message parameters, power parameters, thermal parameters, CPU performance parameters, memory performance parameters, and I/O performance parameters.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an information handling system in accordance with disclosed subject matter;

FIG. 2 illustrates a flow diagram of a conventional process for addressing a BIOS issue;

FIG. 3 illustrates a flow diagram of a process for addressing a BIOS issue in accordance with disclosed subject matter;

FIG. 4 illustrates selected elements of a software architecture for implementing the UEFI extensions disclosed herein.

### DETAILED DESCRIPTION

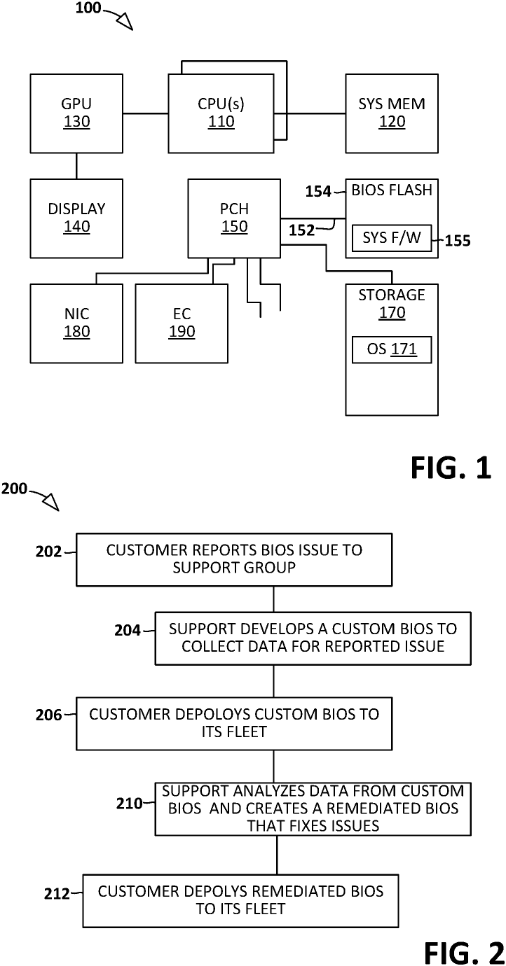

Exemplary embodiments and their advantages are best understood by reference to FIGS. 1-4, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 is a block diagram of an exemplary information handling system 100 (e.g., a laptop computer, tablet computer, etc.) as it may be configured according to one embodiment of the present disclosure. As shown in FIG. 1, IHS 100 may generally include at least one central processing unit (CPU) 110 (e.g., a host processor), a system memory 120, a graphics processor unit (GPU) 130, a display device 140, a platform controller hub (PCH) 150, BIOS flash 154 containing BIOS firmware 155, a trusted platform module 156, a non-volatile memory express(NVMe) storage resource 160, a computer readable storage device 170, a network interface card (NIC) 180, and an embedded controller (EC) 190.

System memory 120 is coupled to CPU 110 and generally configured to store program instructions (or computer program code), which are executable by CPU 110. System memory 120 may be implemented using any suitable memory technology, including but not limited to, dynamic random access memory or any other suitable type of memory. Graphics processor unit (GPU) 130 is coupled to CPU 110 and configured to coordinate communication between the host processor and one or more display components of the IHS. In the embodiment shown in FIG. 1, GPU 130 is coupled to display device 140 and configured to provide visual images (e.g., a graphical user interface, messages and/or user prompts) to the user.

Platform controller hub (PCH) 150 is coupled to CPU 110 and configured to handle I/O operations for the IHS. As such, PCH 150 may include a variety of communication interfaces and ports for communicating with various system components, input/output (I/O) devices, expansion bus(es), and so forth. The PCH 150 illustrated in FIG. 1 interfaces with a BIOS flash 154, containing UEFI system firmware 155, also referred to herein simply as BIOS 155.

Storage device 170 may be any type of persistent, non-transitory computer readable storage device, including non-volatile memory express (NVMe) storage devices and non-PCIe storage devices, such as one or more hard disk drives (HDDs) or solid-state drives (SSDs), and may be generally configured to store software and/or data. For example, computer readable storage device 170 may be configured to store an operating system (OS) 171 for the IHS, in addition to other software and/or firmware modules and user data. As known in the art, OS 171 may contain program instructions (or computer program code), which may be executed by CPU 110 to perform various tasks and functions for the information handling system and/or for the user.

NIC 180 enables IHS 100 to communicate with one or more remotely located systems and/or services 184 via an external network 182 using one or more communication protocols. Network 182 may be a local area network (LAN), wide area network (WAN), personal area network (PAN), or the like, and the connection to and/or between IHS 100 and network 182 may be wired, wireless or a combination thereof. For purposes of this discussion, network 182 is indicated as a single collective component for simplicity. However, it is appreciated that network 182 may comprise one or more direct connections to other remote systems and/or services, as well as a more complex set of interconnections as can exist within a wide area network, such as the Internet. NIC 180 may communicate data and signals to/from IHS 100 using any known communication protocol.

Embedded controller (EC) 190 is generally configured to boot the information handling system and perform other functions. EC 190 may generally include read only memory (ROM), random access memory (RAM) and a processing device (e.g., a controller, microcontroller, microprocessor, ASIC, etc.) for executing program instructions stored within its internal ROM and RAM. For example, EC 190 may be configured to execute program instructions (e.g., a boot block) stored within its internal ROM to initiate a boot process for the information handling system.

FIG. 2 is a flow diagram illustrating a conventional method 200 for addressing BIOS issues reported by end users and/or endpoint devices. The method 200 illustrated in FIG. 2 begins when a customer reports (operation 202) a BIOS issue to a support resource. The support group must then analyze the data and develop (operation 204) a custom BIOS to collect data pertaining to the reported issue. The custom BIOS is then pushed out to the customer, which must then deploy (operation 206) the custom BIOS to its fleet of managed platforms. As data pertaining to the reported issue is collected by the custom BIOS and sent back to the support resource, the data is analyzed (operation 210) and, based on the analysis, a remediated BIOS that resolves the reported issue is created. The remediated BIOS is then pushed out to the customer who must again then deploy the remediated BIOS to its fleet of managed platforms.

It will be readily appreciated by persons of skill in the field of software development that the conventional method 200 just described is inherently undesirable for both the manufacturer of the platform as well as the customer. The release process for a BIOS update, including development and validation, is time consuming and expensive for the manufacturer. Similarly, deploying BIOS updates to a potentially large number of endpoint devices is an expensive and time consuming process for the customer’s information technology department and represents an undesirable productivity interruption. In addition, to the extent that the custom BIOS enables a privileged execution environment to collect the data required to analyze and resolve the reported issue, the custom BIOS version may present an increased security risk when executed on similar device types.

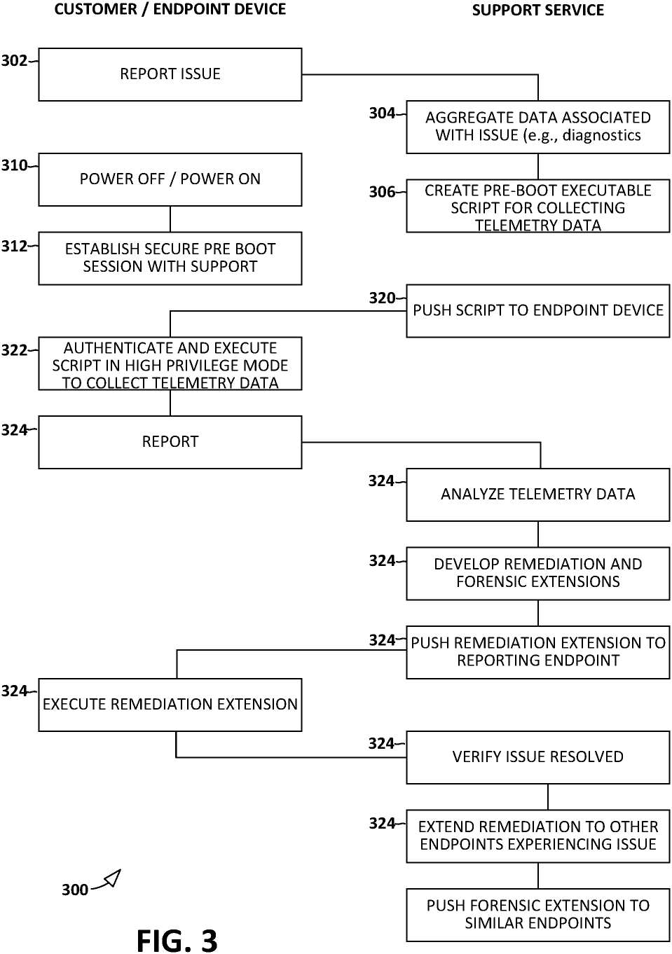

Referring now to FIG. 3, a flow diagram illustrates a method 300 for resolving BIOS issues that addresses and resolves the issues described above with respect to FIG. 2. The illustrated method 300 leverages secure, pre-boot capability for executing authenticated scripts (SPBS) to extend the platform’s telemetry and forensic capabilities. Instead of modifying baseline BIOS firmware two or more times to resolve each reported BIOS issue, the illustrated method 300 deploys executable scripts, also referred to herein as extensions, to temporarily authorize preboot execution of UEFI code in a highly-privileged mode to extend data collection and telemetry to address reported issues in real-time and without modifying the existing UEFI system firmware. The data collected with the extensions may then be provided to a cloud-based supported resource for analysis and creation of a remediation script that resolves the reported issue. The remediated script may then be deployed to any similar system experiencing the same issue. In addition, a forensic script may be developed and distributed to similar platforms that have not reported the issue to proactively identify any platforms that may be vulnerable to reported issue.

In this manner, disclosed subject supports a method for securely adding pre-boot extensions of BIOS telemetry capability to resolve BIOS issues without updating the existing BIOS firmware. Disclosed method further enable proactive application of preboot remediation extensions on other similar systems, even for systems that opt-out of data reporting.

The method 300 illustrated in FIG. 3 begins when A BIOS issue is reported (step 302) from a customer or endpoint device. A cloud-based support service may aggregate (operation 304) information about the reported issue for individual platforms based on the service tag. This aggregated information may include information from pre-boot diagnostics tool reports, 0S/SOS diagnostic reports, and anecdotal customer evidence.

The support service may then create (operation 306) a pre-boot executable script for collecting telemetry data pertaining to the reported issue. At some point after reporting the issue, the endpoint device reboots, e.g., powers off and on (operation 310) and, while in the pre-boot condition, i.e., before loading an operating system, establishes a secure, pre-boot session with the support service.

After establishing the pre-boot secure pre-boot session, the support service may then push (operation 212) the pre-boot script to the endpoint device. The endpoint device may then authenticate and execute (operation 314) the script in a high privilege mode to collect telemetry data pertaining to the reported issue. The telemetry data collected by the script is then reported (operation 316) back to the support service.

The support service may then analyze (operation 320) the collected information and develop (operation 322) a remediation script after determining a suitable remediation for the reported issue. The remediation script is then pushed (operation 324) back to the endpoint device which then executes (operation 330) the remediation extension. Upon verifying (operation 330) that the reported issue has been resolved by the remediation extension, the support service may extend (operation 326) the remediation script to other, similarly configured end point devices.

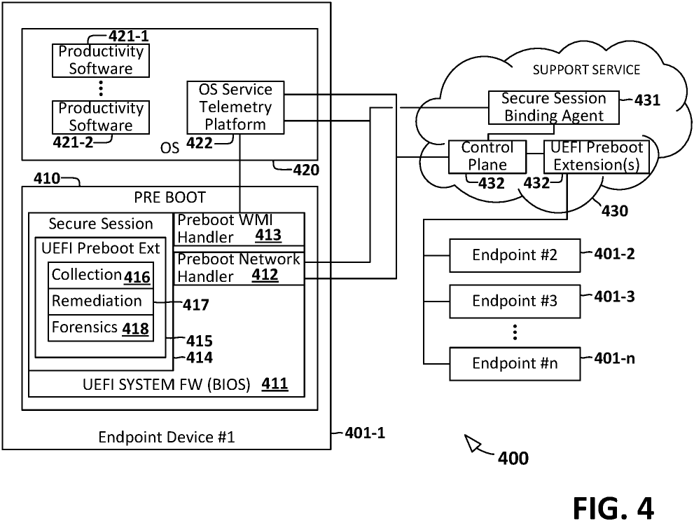

FIG. 4 illustrates selected elements of a software architecture for implementing the UEFI extensions disclosed herein. The architecture 400 illustrated in FIG. 4 includes endpoint devices 1-n (401-1 through 401-n) all coupled to a cloud-based support service 430. For purposes of illustration endpoint device #1 (401-1) is the end-point device that reported the BIOS issue.

Each endpoint device may include software modules similar to the software modules explicitly illustrated for endpoint device #1 (401-1). The software modules illustrated in FIG. 4 for end point device #1 include a UEFI system firmware or BIOS 411 and an operating system 420. The BIOS 411 includes a pre-boot network handler 412 and a pre-boot windows management interface (WMI) 413. The operating system 420 illustrated in FIG. 4 includes one or more instances of productivity software 421 and an OS service telemetry platform 422 configured to support telemetry during runtime, but accessible in the pre-boot state via preboot WMI handler 413.

The support service 430 illustrated in FIG. 4 includes a secure session binding agent 431 coupled, via a control plane 432, to OS service telemetry platform 422 and preboot boot network handler 412. Secure session binding agent 431 is configured to establish a secure and privileged pre-boot session 414 with endpoint device #1 (401-1). Within the pre-boot session 414, may execute any one or more of the executable scripts provided from support service 430, including a collection script 416 for collecting data regarding the BIOS issue, a remediation script 417 for resolving the issue, and a forensic script for proactively identifying candidate platforms, e.g., like-configured endpoint devices 401-2 through 401-n for receiving and implementing the remediation script.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method for resolving a basic input/output system (BIOS) firmware issue affecting one or more information handling systems, wherein the method comprises:
responsive to receiving information indicative of the BIOS firmware issue, developing one or more executable scripts for resolving the BIOS firmware issue without modifying the BIOS firmware, wherein the one or more executable scripts include a first script for collecting data pertaining to the BIOS firmware issue;
pushing the first script to at least one affected information handling system, wherein the first script includes processor-executable instructions for performing pre-boot operations including:
establishing a secure and privileged pre-boot session;
collecting data associated with the BIOS firmware issue from within the secure and privileged pre-boot session; and
sending the data associated with the BIOS issue to a support resource.

2. The method of claim 1, further comprising:
performing analysis of the data associated with the BIOS firmware issue;
developing, based on the analysis, a pre-boot remediation script, wherein the pre-boot remediation script, when executed resolves the BIOS firmware issue; and
pushing the remediation script to the affected information handling system.

3. The method of claim 2, further comprising:
developing, based on the analysis, a pre-boot forensic script to identify susceptibility to the BIOS firmware issue; and
pushing the pre-boot forensic script to one or more like information handling systems wherein the like information handling systems and the affected information handling system share a common configuration.

4. The method of claim 1, wherein collecting data associated with the BIOS firmware issue includes collecting telemetry data generated by telemetry hardware of the information handling system.

5. The method of claim 4, wherein the telemetry hardware includes one or more environmental sensors and wherein the telemetry data is indicative of one or environmental parameters associated with the information handling system.

6. The method of claim 4, wherein the telemetry hardware includes one or model specific registers of the information handling system and wherein the telemetry data is indicative of one or more parameters selected from: system configuration parameters, log message parameters, power parameters, thermal parameters, CPU performance parameters, memory performance parameters, and I/O performance parameters.

7. An information handling system, comprising:
a central processing unit; and
a memory resource, communicatively coupled to the CPU, including processor-executable program instructions that, when executed by the CPU, cause the system to perform basic input output system (BIOS) firmware issue operations comprising:
responsive to receiving information indicative of the BIOS firmware issue, developing one or more executable scripts for resolving the BIOS firmware issue without modifying the BIOS firmware, wherein the one or more executable scripts include a first script for collecting data pertaining to the BIOS firmware issue;
pushing the first script to at least one affected information handling system, wherein the first script includes processor-executable instructions for performing pre-boot operations including:
establishing a secure and privileged pre-boot session;
collecting data associated with the BIOS firmware issue from within the secure and privileged pre-boot session; and
sending the data associated with the BIOS issue to a support resource.

8. The information handling system of claim 7, further comprising:
performing analysis of the data associated with the BIOS firmware issue;
developing, based on the analysis, a pre-boot remediation script, wherein the pre-boot remediation script, when executed resolves the BIOS firmware issue; and
pushing the remediation script to the affected information handling system.

9. The information handling system of claim 8, further comprising:
developing, based on the analysis, a pre-boot forensic script to identify susceptibility to the BIOS firmware issue; and
pushing the pre-boot forensic script to one or more like information handling systems wherein the like information handling systems and the affected information handling system share a common configuration.

10. The information handling system of claim 7, wherein collecting data associated with the BIOS firmware issue includes collecting telemetry data generated by telemetry hardware of the information handling system.

11. The information handling system of claim 10, wherein the telemetry hardware includes one or more environmental sensors and wherein the telemetry data is indicative of one or environmental parameters associated with the information handling system.

12. The information handling system of claim 10, wherein the telemetry hardware includes one or model specific registers of the information handling system and wherein the telemetry data is indicative of one or more parameters selected from: system configuration parameters, log message parameters, power parameters, thermal parameters, CPU performance parameters, memory performance parameters, and I/O performance parameters.

13. A non-transitory computer readable medium including processor-executable program instructions that, when executed by a processor, cause the processor to perform basic input output system (BIOS) firmware issue resolution operations comprising:
responsive to receiving information indicative of the BIOS firmware issue, developing one or more executable scripts for resolving the BIOS firmware issue without modifying the BIOS firmware, wherein the one or more executable scripts include a first script for collecting data pertaining to the BIOS firmware issue;
pushing the first script to at least one affected information handling system, wherein the first script includes processor-executable instructions for performing pre-boot operations including:
establishing a secure and privileged pre-boot session;
collecting data associated with the BIOS firmware issue from within the secure and privileged pre-boot session; and
sending the data associated with the BIOS issue to a support resource.

14. The non-transitory computer readable medium of claim 13, further comprising:
performing analysis of the data associated with the BIOS firmware issue;
developing, based on the analysis, a pre-boot remediation script, wherein the pre-boot remediation script, when executed resolves the BIOS firmware issue; and
pushing the remediation script to the affected information handling system.

15. The non-transitory computer readable medium of claim 14, further comprising:
developing, based on the analysis, a pre-boot forensic script to identify susceptibility to the BIOS firmware issue; and
pushing the pre-boot forensic script to one or more like information handling systems wherein the like information handling systems and the affected information handling system share a common configuration.

16. The non-transitory computer readable medium of claim 13, wherein collecting data associated with the BIOS firmware issue includes collecting telemetry data generated by telemetry hardware of the information handling system.

17. The non-transitory computer readable medium of claim 16, wherein the telemetry hardware includes one or more environmental sensors and wherein the telemetry data is indicative of one or environmental parameters associated with the information handling system.

18. The non-transitory computer readable medium of claim 16, wherein the telemetry hardware includes one or model specific registers of the information handling system and wherein the telemetry data is indicative of one or more parameters selected from: system configuration parameters, log message parameters, power parameters, thermal parameters, CPU performance parameters, memory performance parameters, and I/O performance parameters.
